(19) United States
(12) Patent Application Publication
(10) Pub. No.: US 2026/0156556 A1
(43) Pub. Date: Jun. 4, 2026

(54) Method and Apparatus for Managing Data Channel for Terminal Device

(71) Applicant: Telefonaktiebolaget LM Ericsson (publ), Stockholm (SE)

(72) Inventors: Bin Li, Guangdong Guangzhou (CN); Ting Gao, Guangdong Guangzhou (CN); Xing Tan, Guangdong Guangzhou (CN); Xinzheng Liu, Guangdong Guangzhou (CN)

(21) Appl. No.: 19/134,034

(22) PCT Filed: Dec. 19, 2022
(86) PCT No.: PCT/CN2022/139981

§ 371 Date: May 29, 2025

(51) Int. Cl. H04L 9/40; H04W 72/23; H04W 88/02; H04W 88/06

(52) U.S. Cl. CPC H04W 48/02; H04M 15/62; H04M 15/854; H04W 4/24; H04W 60/04

(57) ABSTRACT

Embodiments of the present disclosure provide a method and an apparatus for managing data channel for terminal device. A method (100) performed by a first network node comprises receiving (S102) a request for setting an indication for a terminal device. The indication indicates to allow a first type of traffic of the terminal device, and to deny a second type of traffic of the terminal device. A method (200) performed by a second network node comprises receiving (S202) an indication indicating to allow a first type of traffic of a terminal device and to deny a second type of traffic of the terminal device. The method (200) further comprises allowing the first type of traffic of the terminal device and denying the second type of traffic of the terminal device (S204). By an indication, the actions of the terminal device could be better supervised.

### TECHNICAL FIELD

The present disclosure relates generally to the technology of communication network, and in particular, to a method and an apparatus for managing data channel for terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

In a communication system, many means are used to improve the security, the efficiency, etc. of communications in the network.

With the rapid development of communication systems, more and more terminal devices are connected to the communication networks. A terminal device needs to be supervised by the network, for the consideration about security or other aspects. For example, when the terminal device does not provide enough registration information or is already in arrears, the terminal device will be deactivated.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

If the terminal device does not provide enough registration information or is already in arrears, its actions should be limited. However, for a terminal device, especially for those related to safety of the user, such as vehicle, wearable devices etc., a complete deactivation may cause great inconvenience or even danger in some scenarios.

Certain aspects of the present disclosure and their embodiments may provide solutions to these or other challenges. There are, proposed herein, various embodiments which address one or more of the issues disclosed herein.

A first aspect of the present disclosure provides a method performed by a first network node. The method comprises a step for receiving a request for setting an indication for a terminal device. The indication indicates to allow a first type of traffic of the terminal device, and to deny a second type of traffic of the terminal device.

In exemplary embodiments of the present disclosure, the request is from a portal and/or a billing system, when the terminal device lacks credit and/or lacks required information.

In exemplary embodiments of the present disclosure, the indication comprises a charging characteristics value.

In exemplary embodiments of the present disclosure, the method may further comprise a step for transmitting the indication for the terminal device to a network storage node.

In exemplary embodiments of the present disclosure, the network storage node comprises a Centralized User Database, CUDB, or a Unified Data Repository, UDR.

In exemplary embodiments of the present disclosure, the method may further comprise a step for merging the indication with data from the network storage node and/or a network data management node.

In exemplary embodiments of the present disclosure, the network data management node comprises a Unified Data Management, UDM, or a Home Subscriber Server, HSS.

In exemplary embodiments of the present disclosure, the method may further comprise a step for transmitting a response with respect to the request.

In exemplary embodiments of the present disclosure, the first type of traffic is for emergency data services. The first network node comprises a provision gateway, PG, or a provision server.

A second aspect of the present disclosure provides a method performed by a second network node. The method comprises a step for receiving an indication indicating to allow a first type of traffic of a terminal device and to deny a second type of traffic of the terminal device. The method further comprises a step for allowing the first type of traffic of the terminal device and denying the second type of traffic of the terminal device.

In exemplary embodiments of the present disclosure, the second network node receives the indication from a Serving GateWay, SGW, during an initial attach procedure of the terminal device.

In exemplary embodiments of the present disclosure, the second network node receives the indication from a Serving GateWay, SGW, during a re-attach procedure initiated by a network side.

In exemplary embodiments of the present disclosure, the method may further comprise a step for determining whether a traffic of the terminal device is the first type or the second type, based on an identity of a node communicating with the terminal device included in the traffic of the terminal device.

In exemplary embodiments of the present disclosure, the second network node obtains the identity of the node, by using internet protocol packet inspection to the traffic of the terminal device.

In exemplary embodiments of the present disclosure, the identity of the node comprises an internet protocol domain, and/or a Uniform Resource Location, URL. The second network node determines the traffic of the terminal device is the first type, when the identity of the node is a preconfigured internet protocol domain, and/or a preconfigured URL.

In exemplary embodiments of the present disclosure, the indication comprises a charging characteristics value.

In exemplary embodiments of the present disclosure, the first type of traffic is for emergency data services. The second network node comprises a Public Data Network Gateway, PGW. The indication is caused when the terminal device lacks credit and/or lacks required information.

A third aspect of the present disclosure provides an apparatus for a first network node. The apparatus for the first network node comprises a processor and a memory. The memory contains instructions executable by the processor. The apparatus for the first network node is operative for receiving a request for setting an indication for a terminal device. The indication indicates to allow a first type of traffic of the terminal device, and to deny a second type of traffic of the terminal device.

In exemplary embodiments of the present disclosure, the apparatus for the first network node is further operative to perform the method according to any of above embodiments.

A fourth aspect of the present disclosure provides an apparatus for a second network node. The apparatus for the second network node comprises a processor and a memory. The memory contains instructions executable by the processor. The apparatus for the second network node is operative for receiving an indication indicating to allow a first type of traffic of a terminal device, and to deny a second type of traffic of the terminal device. The apparatus for the second network node is further operative for allowing the first type of traffic of the terminal device and denying the second type of traffic of the terminal device.

In exemplary embodiments of the present disclosure, the apparatus for the second network node is further operative to perform the method according to any of above embodiments.

A fifth aspect of the present disclosure provides a computer-readable storage medium storing instructions, which when executed by at least one processor, causes the at least one processor to perform the method according to any of above embodiments.

Embodiments herein afford many advantages. According to embodiments of the present disclosure, improved methods and improved apparatuses for managing data channel for terminal device.

By an indication indicating to allow a first type of traffic of the terminal device, and to deny a second type of traffic of the terminal device, the actions of the terminal device could be better supervised. Even when the terminal device does not provide enough registration information or is already in arrears, the terminal device needs not to be deactivated. It is particularly applicable to for those terminal devices related to safety of the user, such as vehicle, wearable devices etc.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart for a method performed by a first network node, according to exemplary embodiments of the present disclosure.

FIG. 1B is an exemplary flow chart showing additional steps of the method showing in FIG. 1A, according to exemplary embodiments of the present disclosure.

FIG. 2A is an exemplary flow chart for a method performed by a second network node, according to exemplary embodiments of the present disclosure.

FIG. 2B is an exemplary flow chart showing additional steps of the method showing in FIG. 2A, according to exemplary embodiments of the present disclosure.

FIG. 3A is a diagram showing a system overview for implementation of the exemplary embodiments of the present disclosure.

FIG. 3B is a diagram showing a Provisioning procedure via PG, according to exemplary embodiments of the present disclosure.

FIG. 3C is a diagram showing a simplified procedure of handshake between BS/portal, PG, HSS, and CUDB, corresponding to FIG. 3B.

FIG. 4 is a diagram showing a process of IP packet inspection inside the PGW after the provisioning procedure, according to embodiments of the present disclosure.

FIG. 5A is a diagram showing a regular Deactivate procedure.

FIG. 5B is a diagram showing a regular initial attach procedure, improved by the embodiments of the present disclosure.

FIG. 5C is a diagram showing a procedure for UE-requested PDU Session Establishment, improved by the embodiments of the present disclosure.

FIG. 6 is a diagram showing a service flowchart, according to exemplary embodiments of the present disclosure.

FIG. 7A is a block diagram showing an exemplary apparatus for a first network node, which is suitable for performing the method according to embodiments of the disclosure.

FIG. 7B is a block diagram showing an exemplary apparatus for a second network node, which is suitable for performing the method according to embodiments of the disclosure.

FIG. 8 is a block diagram showing an apparatus/computer readable storage medium, according to embodiments of the present disclosure.

FIG. 9A is a block diagram showing modules for a first network node, which are suitable for performing the method according to embodiments of the disclosure.

FIG. 9B is a block diagram showing modules for a second network node, which are suitable for performing the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such as an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5 GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device/communication device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

With the rapid development of the Internet of Things, especially with the support of 4G/5G basic communication technology, the door of intelligent Internet of everything has been officially opened to us, and the way people live, work and travel has also ushered in earth-shaking changes again. According to the report “The Mobile Economy 2020” released by GSMA (Global System for Mobile communications Association), the total number of connections in the global Internet of Things (iot) is expected to reach 24.6 billion by 2025, with a compound annual growth rate of 13%.

At the meantime, the supervision to IoT (Internet Of Things) device is becoming more and more essential. For example, a dispatch of <connected vehicle real-name registration management>from MIIT (Ministry of Industry and Information Technology) of China requires all the IoT device connectivity management platform must fulfill the compliance of emergency rescue data services even though the subscriber is run out of credit. If end user does not provide real name information, the operator is entitled to close all the internet services except the emergency rescue internet data services, which is called “data life channel”.

However, conventionally existing system will deactivate the SIM card due to arrearage or refuse to provide real-name information. There will be no internet service.

If the sim card in arrears is reactivated, it will cause unexpected data volume and billing entanglement. Currently no alternative solution to reactivate arrearage subscriber at meanwhile blocking internet access but permit emergency internet data.

Thus, improved methods and apparatuses for managing/supervising the terminal device needs to be provided.

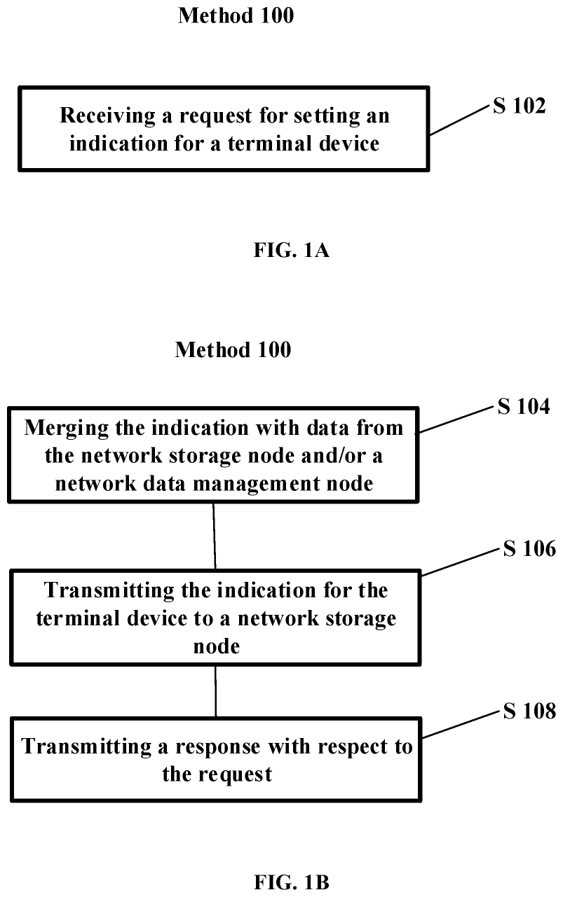

FIG. 1A is an exemplary flow chart for a method performed by a first network node, according to exemplary embodiments of the present disclosure.

As shown in FIG. 1A, a first aspect of the present disclosure provides a method 100 performed by a first network node. The method 100 comprises a step S102 for receiving a request for setting an indication for a terminal device. The indication indicates to allow a first type of traffic of the terminal device, and to deny a second type of traffic of the terminal device.

According to embodiments of the present disclosure, by an indication indicating to allow a first type of traffic of the terminal device, and to deny a second type of traffic of the terminal device, the actions of the terminal device could be better supervised. Even when the terminal device does not provide enough registration information or is already in arrears, the terminal device needs not to be completely deactivated. It is particularly applicable to for those terminal devices related to safety of the user, such as vehicle, wearable devices etc.

In exemplary embodiments of the present disclosure, the request is from a portal and/or a billing system, when the terminal device lacks credit and/or lacks required information.

In exemplary embodiments of the present disclosure, the indication comprises a charging characteristics value.

According to exemplary embodiments of the present disclosure, for the indication, any “tag” or “identification” as indicator, or anything which can differentiate UE type 1 or type 2 traffic, may be used. For example, it may be a 4 bits hexadecimal number (that's 0x0000-0xFFFF) or 0-65535 decimal number. One selected value of the indication may be used to indicate such limited state of the terminal device.

Particularly, a charging characteristics value, which is optional according to 3GPP standards, will be applicable, and the compatibility may be ensured.

FIG. 1B is an exemplary flow chart showing additional steps of the method showing in FIG. 1A, according to exemplary embodiments of the present disclosure.

As shown in FIG. 1B, the method 100 may further comprise a step S106 for transmitting the indication for the terminal device to a network storage node.

In exemplary embodiments of the present disclosure, the network storage node comprises a Centralized User Database, CUDB, or a Unified Data Repository, UDR.

According to embodiments of the present disclosure, the indication will be stored in the network storage node, and thus other network node may operate correspondingly.

In exemplary embodiments of the present disclosure, the method may further comprise a step S104 for merging the indication with data from the network storage node and/or a network data management node.

In exemplary embodiments of the present disclosure, the network data management node comprises a Unified Data Management, UDM, or a Home Subscriber Server, HSS.

According to embodiments of the present disclosure, the indication may be handled with necessary operations (such as add, delete or modify), and then to be transmitted to the network storage node.

In exemplary embodiments of the present disclosure, the method may further comprise a step S108 for transmitting a response with respect to the request.

In exemplary embodiments of the present disclosure, the first type of traffic is for emergency data services. The first network node comprises a provision gateway, PG, or a provision server.

According to embodiments of the present disclosure, the data life channel may be ensured even when the terminal device lacks credit and/or lacks required information.

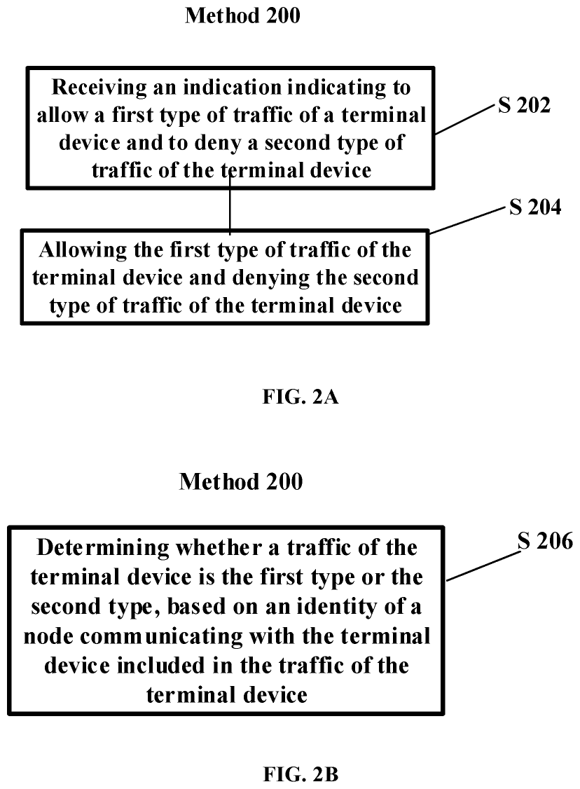

FIG. 2A is an exemplary flow chart for a method performed by a second network node, according to exemplary embodiments of the present disclosure.

As shown in FIG. 2A, a second aspect of the present disclosure provides a method 200 performed by a second network node. The method 200 comprises a step S202 for receiving an indication indicating to allow a first type of traffic of a terminal device and to deny a second type of traffic of the terminal device. The method 200 further comprises a step S204 for allowing the first type of traffic of the terminal device and denying the second type of traffic of the terminal device.

In exemplary embodiments of the present disclosure, the second network node receives the indication from a Serving GateWay, SGW, during an initial attach procedure of the terminal device.

In exemplary embodiments of the present disclosure, the second network node receives the indication from a Serving GateWay, SGW, during a re-attach procedure initiated by a network side.

According to embodiments of the present disclosure, the indication may start to be effective to the terminal device, during the terminal device's initial attach procedure, namely, when the terminal device initially connects to the network. Or, the indication may start to be effective to the terminal device, during the terminal device's re-attach procedure, namely, when the network side request the terminal device stop the current network connection and then attach to the network again.

FIG. 2B is an exemplary flow chart showing additional steps of the method showing in FIG. 2A, according to exemplary embodiments of the present disclosure.

As shown in FIG. 2B, the method 200 may further comprise a step S206 for determining whether a traffic of the terminal device is the first type or the second type, based on an identity of a node communicating with the terminal device included in the traffic of the terminal device.

In exemplary embodiments of the present disclosure, the second network node obtains the identity of the node, by using internet protocol packet inspection to the traffic of the terminal device.

In exemplary embodiments of the present disclosure, the identity of the node comprises an internet protocol domain, and/or a Uniform Resource Location, URL. The second network node determines the traffic of the terminal device is the first type, when the identity of the node is a preconfigured internet protocol domain, and/or a preconfigured URL.

In exemplary embodiments of the present disclosure, the indication comprises a charging characteristics value.

In exemplary embodiments of the present disclosure, the first type of traffic is for emergency data services. The second network node comprises a Public Data Network Gateway, PGW. The indication is caused when the terminal device lacks credit and/or lacks required information.

According to embodiments of the present disclosure, the existing system process is revamped to not deactivating the SIM card, even when the subscriber is in arrears or refusing to provide the real-name information, etc.

API (application program interface) is provided for operator/Enterprise to manage the target subscriber, without APN (Access Point Name) profile or any other subscription data changed.

Packet inspection technology may be implemented to detect the data service, and it can deny all the usual internet request but permit the life channel data request.

The billing account may be adjusted to exclude the life channel data fee, or split billing for the life channel data from regular internet volume. For example, such billing for the life channel data may be covered by insurance or enterprise.

According to embodiments of the present disclosure, a new system process of IoT device connectivity platform to manage the in arrears subscriber for compliance requirement may be provided. A packet inspection module to classify the internet data services with tags may be provided. A few APIs to make the directional-internet-access management simple and efficiency may be provided. A new charging method to exclude or split the life channel data billing from regular internet service may be provided.

With such solutions in the embodiments of the present disclosure, following advantages may be provided.

1. There is no need to change the 3GPP Core Network architecture, and no service impact to the subscribed vehicle on the road. It supplies seamless internet services.

2. The connected-vehicle subscriber can still keep access to the internet with data life channel even in arrears, the internet access can be controlled safely without subscription data change by using packet inspection technology.

3. The connected-vehicle subscriber can still keep access to the internet with data life channel even refusing to provide real-name information to the authorities, the internet access can be controlled safely without subscription data change by using packet inspection technology.

4. The packet inspection technology is implemented to inspect the life channel internet access and the APIs are encapsulated to enterprise and operator, the time to market can be speeded up to take the preemptive opportunities.

5. The compliance of MIIT NO.246 document, etc. may be fulfilled. An efficient and strong IoT platform may be promptly built up against other competitors.

6. It can help operator and enterprise to increase revenue and to control the risk.

For further illustrating the technical solutions, description about further detailed exemplary embodiments includes following 3 parts.

Part1 is about installing the DATA GW (gateway) with packet inspection module.

In this part 1, enterprise APN may be modified to define a user-category in EPS or user-profile-selection in 5GC and to define a charging characteristics (CC) value.

Enterprise APN configuration may be modified with Packet Inspection of life channel domain/ip/url etc., the life channel data may be tagged with a service data id (SDID).

A new rating group ids (RG) may be designed to group the data volume of life channel and data volume of regular internet service. With different RGs, the platform can charge differently.

Part2 is about installing a provisioning GW.

In this part2, 2 conditions may be designed as the service change trigger. The 2 conditions may be “users in arrears” and “users refusing real-name registration”. The operator or enterprise shall estimate which end-user meets the 2 afore-mentioned conditions.

API may be invoked for provisioning the charging characteristic (CC) value to the user subscription data, which is stored in database. In the subsequent signaling procedures of “update location request and response” from MME to HSS in EPC or Nudm_SubscriberDataManagement_Get from SMF to UDM in 5GC, the UE will get the 3gppChargingCharacteristic from HSS. And during “create session request” from SGW to PGW in ECP or “Nsmf_PDUSession_CreateSM Context Request” from AMF to SMF in 5GC, UE will activate and behave according to the predefined user-category in EPC or user-profile-selection in 5GC with a predefined charging characteristic values as triggers. In this scenario, for example, a user with CC=11 within user-category=11 can only access data life channel ip/domain/url. The other users with default CC value and user category can access internet without restrictions.

API permission will be given to Enterprise and operator to manage the enterprise user.

Part 3 is about billing handling mechanism.

The APN configuration may be modified, a Rating Group (RG) may be predefined to contain the SDID of the specific life channel data. By this means all the life channel data inspected with SDID will in charge in this RG for billing.

According to the data accumulation generated in a row charging data record (CDR) with a data life channel RG, the billing is split from regular internet data.

After these 3 procedures, when UE is tagged with a specific CC value, it means the UE can only access life data channel service, while blocking other internet service and relevant bill deduction.

Such life channel data service solution is based on 3GPP core network, that means not only vehicle but also other industry end-users, such as 3G/4G Wearable devices for the elderly & children can also benefit from this solution. It's a scalable solution in many scenarios. For example, when the elderly might fall down, the fall down warning message shall be sent to the IoT platform even the sim card is lack of credit. The last time location of a missing child should be sent to the authorities even the real name is not register yet. They are also called “life channel data service”.

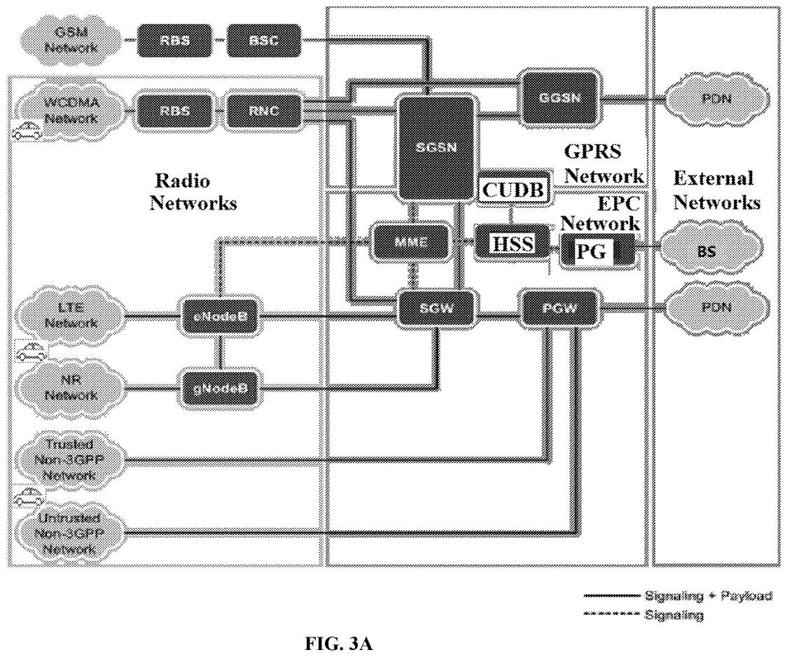

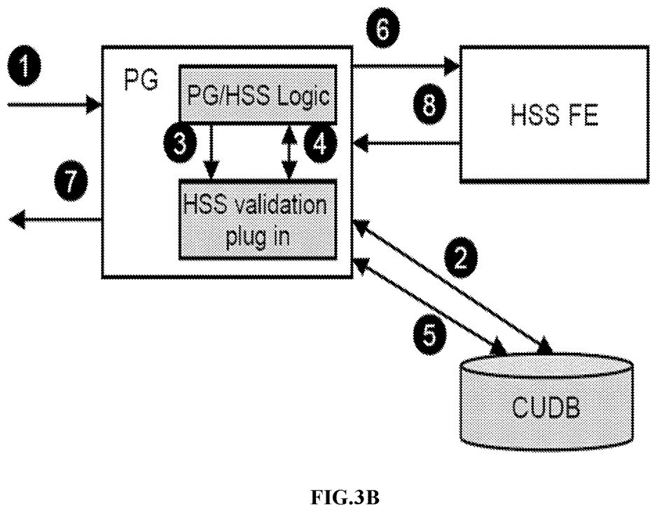

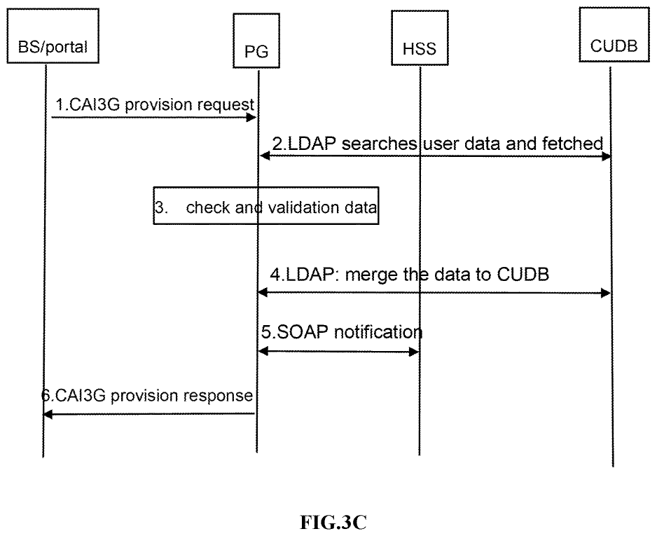

FIG. 3A is a diagram showing a system overview for implementation of the exemplary embodiments of the present disclosure.

As shown in FIG. 3A, an example scenario for the embodiments of the present disclosure may be a communication system including radio networks, core networks (GPRS network, EPC network), and external networks.

The radio networks may include GSM (Global System for Mobile communications) network, WCDMA network, LTE network, NR network, trusted non-3GPP network, and untrusted non-3GPP network.

The GSM network may include RBS (Radio Base Station), BSC (Base Station Controller). The WCDMA network may include RBS (Radio Base Station), RNC (Radio Network Controller).

The LTE network may include eNodeB, the NR network may include gNodeB.

The core networks may include GGSN, SGSN, CUDB (Centralized User Database), MME, HSS, PG (provision gateway), SGW, PGW.

The external networks may include PDN, BS (Billing System).

FIG. 3B is a diagram showing a Provisioning procedure via PG, according to exemplary embodiments of the present disclosure.

As shown in FIG. 3B, there may be following steps. For clear illustration, some important steps for implementation of the embodiments are underlined.
1. A provisioning request, e.g., set CC= “11 or 12” is received by the PG and its syntax is validated.
2. A check if any data exists in the CUDB for the given request is performed by Provisioning GW (PG), if found, the data is fetched from centralized user data base (CUDB).
3. PG merge received data from request with fetched data (default CC) from CUDB and send it to the HSS validator plug-in.
4. The “HSS validator plug-in” performs validation of subscriber data. PG fetches the result from the “HSS validator plug-in”.
5. PG merges requesting data with CUDB data and possible mutation data from the HSS validator plug-in. Add, delete or modify operations (modify default CC value to 11 or 12) are performed towards CUDB for the merged data.
6. A notification of changed data is sent to HSS-front end.
7. A response is sent back to the originating system. In exemplary embodiments, it may be the Billing System (BS).
8. A notification response is received from the HSS-FE if a notification was sent. Since the communication is asynchronous, the response may or may not come before the CAI3G response in step 7.

Incase it's a 5G vehicle/device, the provisioning network element should refer to “UDM” instead of “HSS”, “UDR (Unified Data Repository)” instead of CUDB, “PG” will be replaced by “provision server”. PGW may be replaced with “UPF”.

FIG. 3C is a diagram showing a simplified procedure of handshake between BS/portal, PG, HSS, and CUDB, corresponding to FIG. 3B. For clear illustration, some important steps for implementation of the embodiments are underlined.

As shown in FIG. 3C, the procedure includes following steps.
1. A CAI3G provisioning request, e.g., set CC=″11 or 12″ is received and its syntax validated.
2. A check if any data exists in the CUDB for the given request is performed by PG, if found, the data is fetched from CUDB.
3. PG check and validate the user data inside the PG.
4. PG merges “requesting data” with “CUDB data” and possible mutation data from the HSS validator plug-in. Add, delete or modify operations (modify default CC value to 11 or 12) are performed towards CUDB for the merged data.
5. A notification (such as a SOAP (Simple Object Access Protocol) notification) of changed data is sent to HSS-front end. Furthermore, HSS will forward the notification to MME which is not the focus part of Provisioning procedure.
6. A CAI3G provision response is sent back to the originating system. In embodiments, it may be the customer portal or BS.

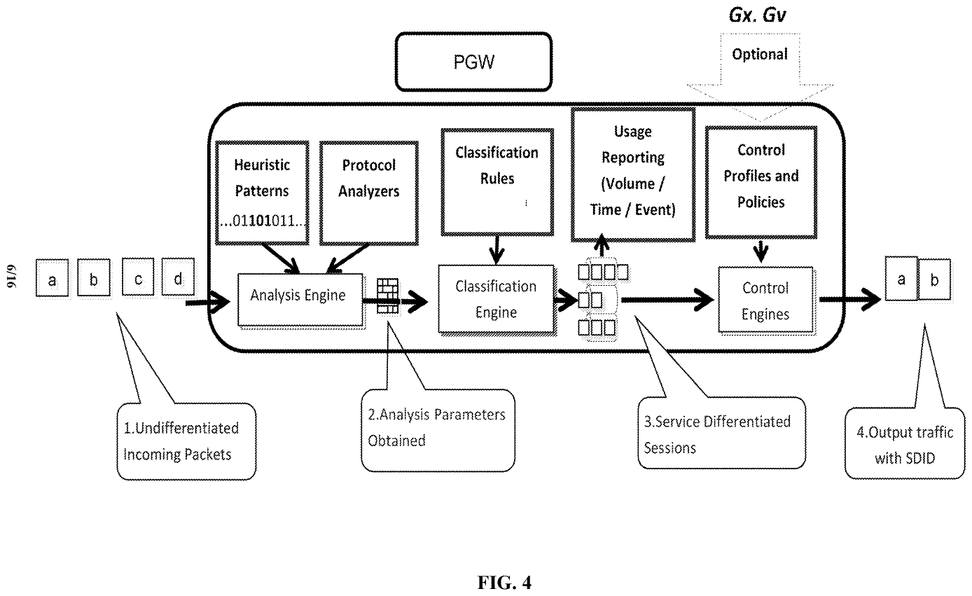

FIG. 4 is a diagram showing a process of IP packet inspection inside the PGW after the provisioning procedure, according to embodiments of the present disclosure.

As shown in FIG. 4, the process of IP packet inspection includes following steps.
1. In steps 1, undifferentiated incoming packets (such as a, b, c, d) go into PGW Analysis Engine to Performs analysis. The PGW Analysis Engine may include heuristic and protocol patterns.
2. Step 2 is the output of step 1, with analysis parameters obtained after analysis. The analyses may include analysis for the IP/Domain/Port/protocol. Then it goes into a Classification engine, which classify the incoming packets (such as a, b, c, d), using classification rules.
3. Step 3 is the output of step 2, the classification engine initials the service classification sessions, and assign the SDID to the services. Then it goes into control engines. At the meantime, the usage of volume/time/event will be recorded and reported to generate the CDR.
4. Step 4 is the output of step3, the control engines do the judgement with a permit or deny the service based on the policy from 3GPP Gx/Gy interface or based on PGW local configuration. The 3GPP Gx/Gy policy is optional. The PGW local policy control may be with a default configuration of “deny”. That means the data life channel configuration (IP domain or URL) shall be explicitly configured into PGW

As an exemplary output, the data packets a, b may be allowed, and data packets c, d may be denied.

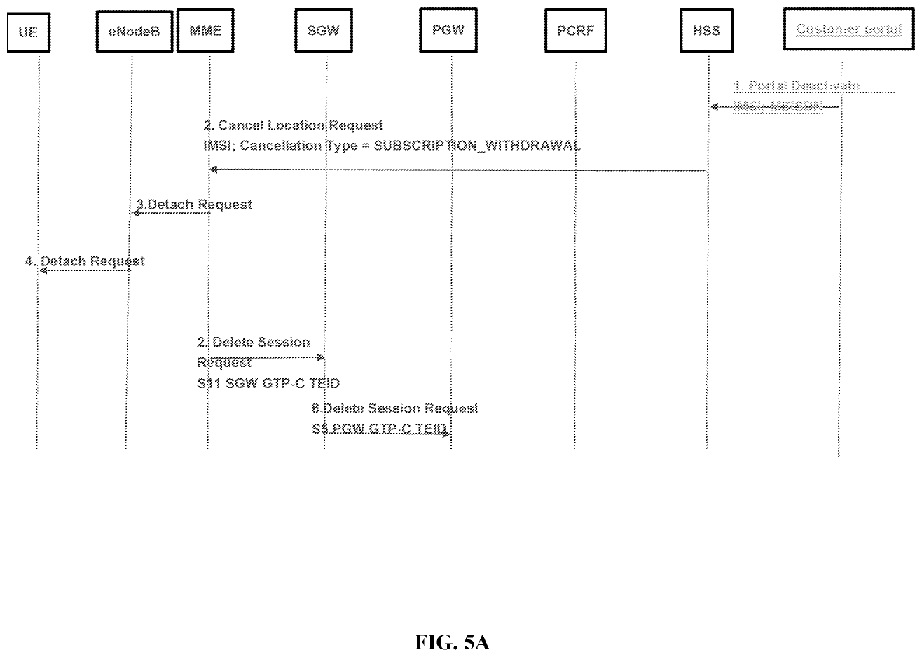

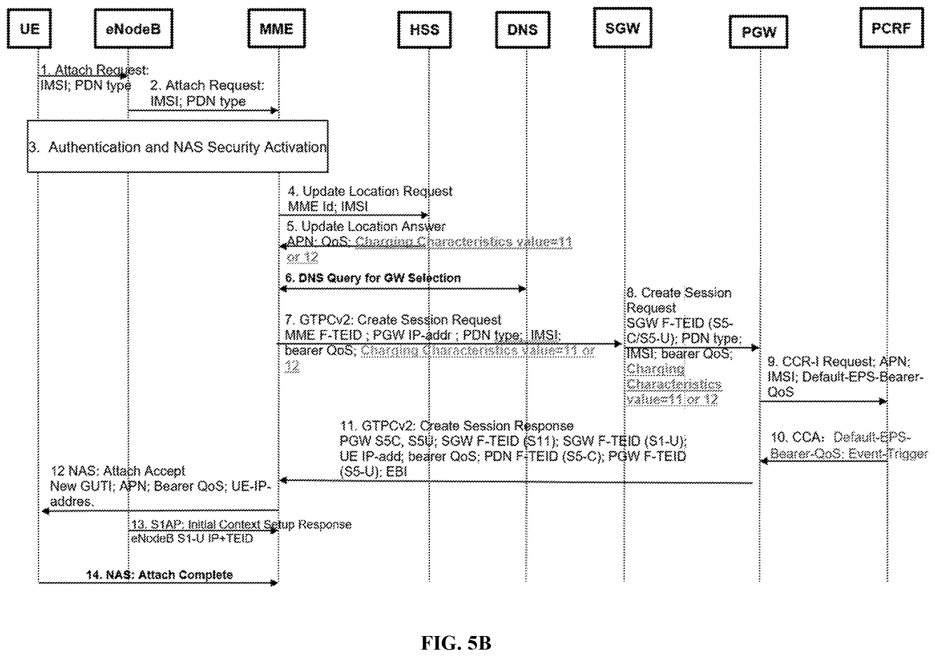

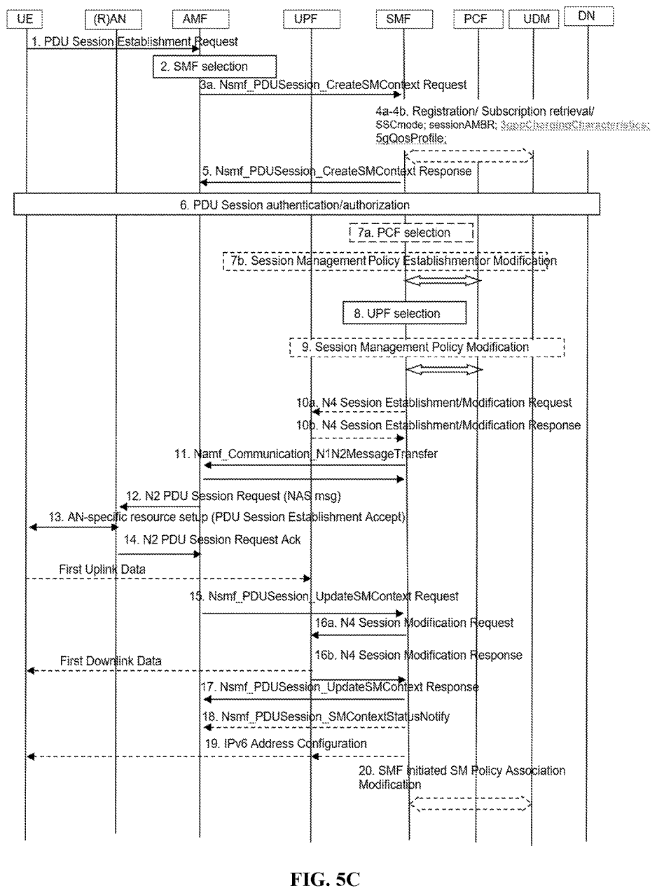

FIG. 5A is a diagram showing a regular Deactivate procedure.

As shown in FIG. 5A, currently there is a regular Deactivate procedure when subscriber is “in arrear” or “do not fulfill with legal”, it's initial by Operator or Enterprise from customer portal.

This deactivates action from customer portal will initial a Cancel Location Request signaling from HSS and Delete Session Request to the PGW. By the end, the bearer of UE will be deleted, and the UE is detached form network.

The procedure as shown in FIG. 5 may include following steps.

In a step 1, a request for deactivating a UE may be sent via the customer portal. The request may include IMSI (International Mobile Subscriber Identity), MSISDN (Mobile Subscriber Integrated Services Digital Number).

In a step 2, a cancel location request may be sent from HSS to MME. The request include IMSI, Cancellation Type=Subscription_Withdrawal.

In a step 3, a detach request may be sent from MME to eNodeB.

In a step 4, a detach request may be sent from the eNodeB to the UE.

In a step 5, a delete session request may be sent from MME to SGW. The request may include S11 SGW GTP-C(GPRS tunnelling protocol-control) TEID (Tunnel End Point identifier).

In a step 6, a delete session request may be sent from SGW to PGW. The request may include S5 PGW GTP-C TEID.

According to embodiments of the present disclosure, instead of deactivating the UE, embodiments will revamp the process with a “Provisioning request” (refer to FIG. 3B) by the data life channel feature in the customer portal.

By this means the UE will not be detached from network. There will be no service impact to the vehicle subscriber especially when they are driving. Seamless service is one of the advantages of the proposed solution.

During a subscription process, the CC could be a default subscription data. For example, a new car with a SIM card will subscribe a default CC=8 to get a full access to the network and then the CC value may be modified via API according to FIG. 3C to provisioning a new CC=12 to get a minimum internet access, which may be life data channel service.

In fact, CC as a tag assigned to a UE, could be also useful in the scenario where a UE wants to change internet access policy base on some condition, such as different province with different internet access policy.

The CC value, no matter as a default subscription data or as a data modified via API at any time, it will not impact the currently internet service, UE will be controlled at next attach procedure.

FIG. 5B is a diagram showing a regular initial attach procedure, improved by the embodiments of the present disclosure.

As shown in FIG. 5B, the detailed handshake procedure may include following steps.

1-2. The UE (or a vehicle DCM) initiates the Attach procedure by sending an Attach Request message, which includes the IMSI, the IMEI (International Mobile Equipment Identity), or the GUTI (Globally Unique Temporary UE Identity) and, if it is available, the last visited registered TAI (Tracking Area Identity), through the eNodeB to the MME.

3. Security functions can be performed, for example, to authenticate a subscriber. A security context is established, ciphering and integrity protection are negotiated. The IMEI Check procedure can also be performed. If the Attach Request message does not have integrity protection or fails the integrity check, the MME can initiate NAS message security enhancement by including a HashMME IE in the Security Mode Command message sent to the UE.

4-5. The MME sends an Update Location Request to the HSS in the following scenarios:
The UE provides an IMSI.
The TAI supplied by the eNodeB is different from that of the GUTI of the UE.
There is no valid subscription data for the UE in the new MME.

This is to inform the HSS about the identity of the MME currently serving the user and to get subscription data. The message contains the user state and location information, such as MSISDN, APN, AMBR (Aggregate Maximum Bit Rate), Support Features, and 3GPP-charging-characteristic value.

From https://www.3gpp.org/ftp/Specs/archive/32 series/32.298/(32298-8m0.zip) (3GPP TS 32.298 V8.22.0 (2016-06)) clause 5.1.2.2.7, the Charging Characteristics field allows the operator to apply different kind of charging methods in the CDRs. A subscriber may have Charging Characteristics assigned to his subscription. These characteristics can be supplied by the HLR (Home Location Register)/HSS (Home Subscriber Server) to the SGSN/MME as part of the subscription information, and, upon activation of an IP-CAN (Internet Protocol-Connectivity Access Network) bearer, the SGSN/MME forwards the charging characteristics to the GGSN/SGW (see procedures 7-8).

In embodiments as show in FIG. 4, it sets a CC=11 or 12 to UE as a subscription data. The CC=11 represent an action by Enterprise to setup a data life channel vehicle subscriber. And CC=12 means Operator setup a vehicle subscriber as a data life channel user.

6. MME sends DNS query for PGW selection.

7-8. If the Attach Request message contains a PDN Connectivity Request message, the MME uses the subscription data to verify that the APN that is requested by the UE is allowed and determines which PGW to contact. The MME sends the Create Session Request message (via a GTPCv2 protocol message) through the SGW to the PGW to start establishing a default EPS bearer.

During the EPS bearer establishing, MME forwards the charging characteristics to the PGW though SGW. And PGW selects User category with a CC value to activate PDN connection.

During selecting the User category, there is a predefined rule-space to control the vehicle to access the emergency internet service. These services are predefined in “data life channel” shown as IP domain or URLs, from Layer 3 to layer 7 according to Open System Interconnection (OSI) 7 layers module.

F TEID refers to Full Qualified TEID.

9-11. The PGW creates an entry in the EPS (Evolved Packet System) bearer context table and generates a Charging ID. After negotiating with the PCRF, the PGW sends a Create Session Response message through the SGW to the MME.

CCR-I refers to Credit-Control-Request-Initial. CCA refers to Credit-Control-Answer. EBI refers to evolved packet system bearer identity.

12. The MME sends the Attach Accept message to the eNodeB, which is forwarded to the UE.

13. The eNodeB sends the Initial Context Setup Response message to the MME after the bearers toward the UE are set up. This message contains the TEID and the IP address of the eNodeB for user plane traffic.

14. The UE sends the Attach Complete message containing the identity of the bearers through the eNodeB to the MME.

The solutions in embodiments of the present disclosure could be Scalable at least in 2 following dimensions.

One is for different industries, such as Wearable devices industry.

In this scenario, if the elder person falls down, the warning message detected by sensor shall or must be sent to the IoT platform, even when the sim card is lack of credit or without real-name registration.

Another scenario is for obtaining location of missing children or pet. The last visit location shall be sent to IoT platform before device powers-off, even when the sim card is lack of credit or without real-name registration.

Another is for different Radio Access Network (RAN) technologies, such as 3G/4G/5G/6G, etc.

Attach and Create Session Request are essential in 4G EPC network. The “Attach” and “Create PDP context request” in 3G Core network and the “PDU Session Establishment” in 5GC are similar with 4G procedure. It's up to the device with different 3G/4G or 5G wireless module, or even 6G module, etc. in further.

For example, in case it's a 5G IoT device, the handshake procedure shall follow with 3GPP TS 23.502 V17.6.0 (2022-09) clause 4.3.2 “UE Requested PDU Session Establishment”.

FIG. 5C is a diagram showing a procedure for UE-requested PDU Session Establishment, improved by the embodiments of the present disclosure.

1. The UE sends an N1 PDU Session Establishment Request message to the AMF.

2-3. The AMF selects an SMF, and then sends an Nsmf_PDUSession CreateSMContext Request message to the SMF.

4a-4b. the SMF retrieves the session management subscription data by sending an Nudm_SubscriberDataManagement_Get Request message to the selected UDM.

The UDM responds with an Nudm_SubscriberDataManagement_Get Response message, including single NSSAI (Network Slice Selection Assistance Information) and DnnConfiguration attribute, and including SSCmode (Session and Service Continuity); sessionAMBR; 3gppChargingCharacteristics; 5gQosProfile etc.

5. The SMF responds with an Nsmf_PDUSession_CreateSMContext Response message to the AMF

6. PDU Session authentication/authorization.

7a-7b. The SMF sends a Npcf_SMPolicyControl_Create Request message to the selected PCF. The PCF responds with an Npcf_SMPolicyControl_Create Response message to the SMF

8-10b. The SMF initiates UPF selection, sends a PFCP Session Establishment Request message to the UPF to allocate the CN tunnel. The UPF sends a PFCP Session Establishment Response message to the SMF.

11. SMF to AMF: Namf_Communication_NIN2MessageTransfer.

12. AMF to (R)AN: N2 PDU Session Request

13. (R)AN forwards the NAS message (PDU Session ID, PDU Session Establishment Accept) provided in step 12 to the UE.

14. (R)AN to AMF: N2 PDU Session Response.

15. The AMF sends an Nsmf_PDUSession_UpdateSMContext Request message to the SMF with the N2 PDU Session Resource Setup Response Transfer message.

16a-16b. The SMF initiates an N4 Session Modification procedure with the UPF, The UPF provides an N4 Session Modification Response to the SMF.

17-18. SMF to AMF: Nsmf_PDUSession_UpdateSMContext Response and Nsmf PDUSession_SMContextStatusNotify.

19. SMF to UE: In the case of PDU Session Type IPV6 or IPv4v6, the SMF generates an IPV6 Router Advertisement and sends it to the UE.

20.SMF initial a SM Policy Association Modification to UDM.

The CHF selection by the AMF is done during the Registration process based on charging characteristic is not related with this invention and will not appear in the handshake.

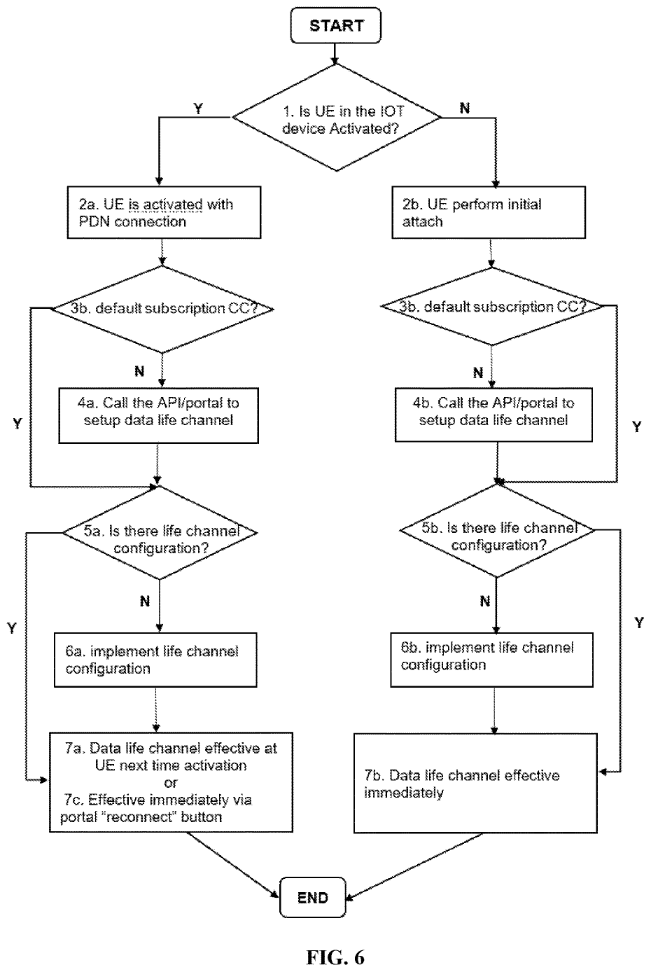

FIG. 6 is a diagram showing a service flowchart, according to exemplary embodiments of the present disclosure.

As shown in FIG. 6, the procedure may include following steps.

Step 1 will check the UE status, for example a UE in a vehicle.

If the UE is activated, then the procedure goes into step 2a, otherwise goes into 2b to perform a “initial attach”.

2a. For a UE which is already activated, that means the UE is already active to the network with a PDN connection. Then the procedure goes into step 3a.

2b. For a UE needing an initial attach, then UE performs an initial attach to the network. (It could be the driver starting the engine to make the vehicle connected to the RAN network.)

This step is mapping to the previous handshake protocol as shown in FIG. 5B about Signaling Procedure, step 1-3, including “attach request” and “update location request” procedures.

Then the procedure goes into step 3b.

3a. For a UE which is already activated, if the UE doesn't have a default subscription CC data, then the procedure goes into step 4a to call the API or using a Portal to setup data life channel function.

If the UE is with a default subscription CC data, then the procedure skips to step 5a.

This step is mapping to handshake protocol as shown in FIG. 5B about Signaling Procedure, step 4-5, including “update location request and answer” signaling.

3b. For a UE performing initial attach, if the UE doesn't have a default subscription CC data, then the procedure goes into step 4b to call the API or using a Portal to setup data life channel function.

If the UE is with a default subscription CC data, then the procedure skips to step 5b.

This step is mapping to handshake protocol as shown in FIG. 5B about Signaling Procedure, step 4-5, including “update location request and answer” signaling.

4a. For a UE which is already activated, customer or operator call the API or portal to setup a data life channel function. Then the procedure goes into step 5a.

This step is mapping to Provisioning process as shown in FIG. 3B about Provisioning User Data via PG.

4b. For a UE performing initial attach, customer or operator can call the API or portal to setup a data life channel function. Then go into step 5b.

This step is mapping to Provisioning process as shown in FIG. 3B about Provisioning User Data via PG.

5a. For a UE which is already activated, system will check the data life channel configuration. If the “commit-check” result is failure, then the procedure goes into step 6a to implement the data. Otherwise, the procedure skips to 7a.

5b. For a UE performing initial attach, system will check the data life channel configuration. If the “commit-check” result is failure, then the procedure goes into step 6b to implement the data. Otherwise the procedure skips to 7b.

6a. In this step, for a UE which is already activated, Enterprise's life channel data should be used as an input for implementation into the Packet GW. The data could be an URL or IP address etc.

6b. In this step, for a UE performing initial attach, Enterprise's life channel data should be used as an input for implementation into the Packet GW. The data could be an URL or IP address etc.

7a. For a UE which is already activated, this step will finish the flowchart, but the life channel function will be effective at UE at next time for activation. No service impact is caused.

This is mapping to handshake protocol as shown in FIG. 5B about Signaling Procedure, step 6-14, including “Create Session request and response” and “attach accept” and “attach completed” signaling.

That means that the UE will be permitted to access the predefined life channel URL or IP address, but other internet service will be denied.

Under some situations, operator needs the data life channel effective immediately. Then check step 7c.

7c. For a UE which is already activated, operator/Authority may want it effective immediately via the “reconnect” button on customer portal. This will initial a “cancel location request” from HSS to MME with a “re-attach” AVP (attribute value property).

7b. For a UE performing initial attach, this step will finish the flowchart and the life channel function will be effective immediately.

This is mapping to handshake protocol as shown in FIG. 5B about Signaling Procedure, step 6-14, including “Create Session request and response” and “attach accept” and “attach completed” signaling.

That means the UE will be permitted to access the predefined life channel URL or IP address, but other internet service will be denied.

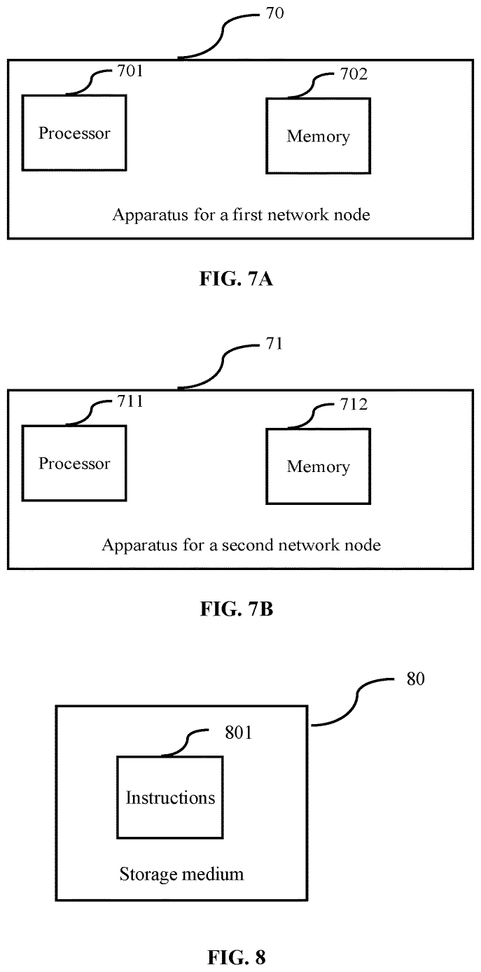

FIG. 7A is a block diagram showing an exemplary apparatus for a first network node, which is suitable for performing the method according to embodiments of the disclosure.

As shown in FIG. 7A, the apparatus 70 for the first network node comprises: a processor 701, a memory 702. The memory 702 contains instructions executable by the processor 701. The apparatus 70 for the first network node is operative for receiving a request for setting an indication for a terminal device. The indication indicates to allow a first type of traffic of the terminal device, and to deny a second type of traffic of the terminal device.

In embodiments of the present disclosure, the apparatus 70 is further operative to perform the method according to any of the above embodiments, such as these shown in FIG. 1A, 1B, etc.

FIG. 7B is a block diagram showing an exemplary apparatus for a second network node, which is suitable for performing the method according to embodiments of the disclosure.

As shown in FIG. 7B, the apparatus 71 for the second network node comprises: a processor 711, a memory 712. The memory 712 contains instructions executable by the processor 711. The apparatus 71 for the second network node is operative for receiving an indication indicating to allow a first type of traffic of a terminal device, and to deny a second type of traffic of the terminal device. The apparatus 71 for the second network node is further operative for allowing the first type of traffic of the terminal device and denying the second type of traffic of the terminal device.

In embodiments of the present disclosure, the apparatus 71 is further operative to perform the method according to any of the above embodiments, such as these shown in FIG. 2A, 2B, etc.

The processors 701, 711 may be any kind of processing component, such as one or more microprocessor or microcontrollers, as well as other digital hardware, which may include digital signal processors (DSPs), special-purpose digital logic, and the like. The memories 702, 712 may be any kind of storage component, such as read-only memory (ROM), random-access memory, cache memory, flash memory devices, optical storage devices, etc.

Particularly, the communication device may be a UE referring to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The processors 701, 711 may be configured to process instructions and data and may be configured to implement any sequential state machine operative to execute instructions stored as machine-readable computer programs in the memory. The processors 701, 711 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processors 701, 711 may include multiple central processing units (CPUs).

The memories 702, 712 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memories 702, 712 include one or more application programs, such as an operating system, web browser application, a widget, gadget engine, or other application, and corresponding data. The memories 702, 712 may store, for use by the UE, any of a variety of various operating systems or combinations of operating systems.

The memories 702, 712 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memories 702, 712, which may be or comprise a device-readable storage medium.

FIG. 8 is a block diagram showing an apparatus/computer readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 1A, 1B, 2A, 2B, etc.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

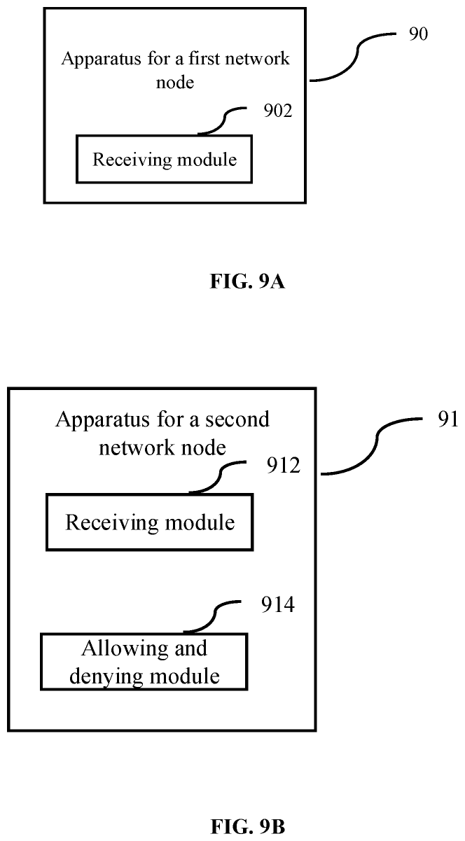

FIG. 9A is a block diagram showing modules for a first network node, which are suitable for performing the method according to embodiments of the disclosure.

As shown in FIG. 9A, the apparatus 90 for the first network node may comprise: a receiving module 902, configured for receiving a request for setting an indication for a terminal device.

In embodiments of the present disclosure, the apparatus 90 is further operative to perform the method according to any of the above embodiments, such as these shown in FIG. 1A, 1B, etc.

FIG. 9B is a block diagram showing modules for a second network node, which are suitable for performing the method according to embodiments of the disclosure.

As shown in FIG. 9B, the apparatus 91 for the second network node may comprise: a receiving module 912, configured for receiving an indication indicating to allow a first type of traffic of a terminal device and to deny a second type of traffic of the terminal device; and an allowing and denying module 914, configured for allowing the first type of traffic of the terminal device and denying the second type of traffic of the terminal device.

In embodiments of the present disclosure, the apparatus 91 is further operative to perform the method according to any of the above embodiments, such as these shown in FIG. 2A, 2B, etc.

These modules may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

The first network node, the second network node may be any communication device, and/or computing device in a network, such as any server, router, gateway device, etc. Examples structures for the terminal device (such as a UE), first network node, and/or the second network node may be illustrated as follows.

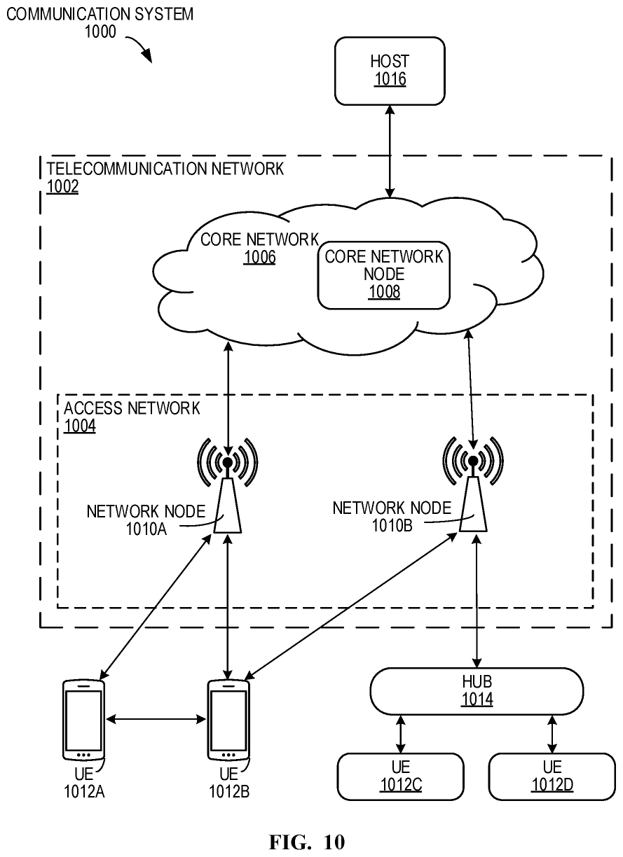

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

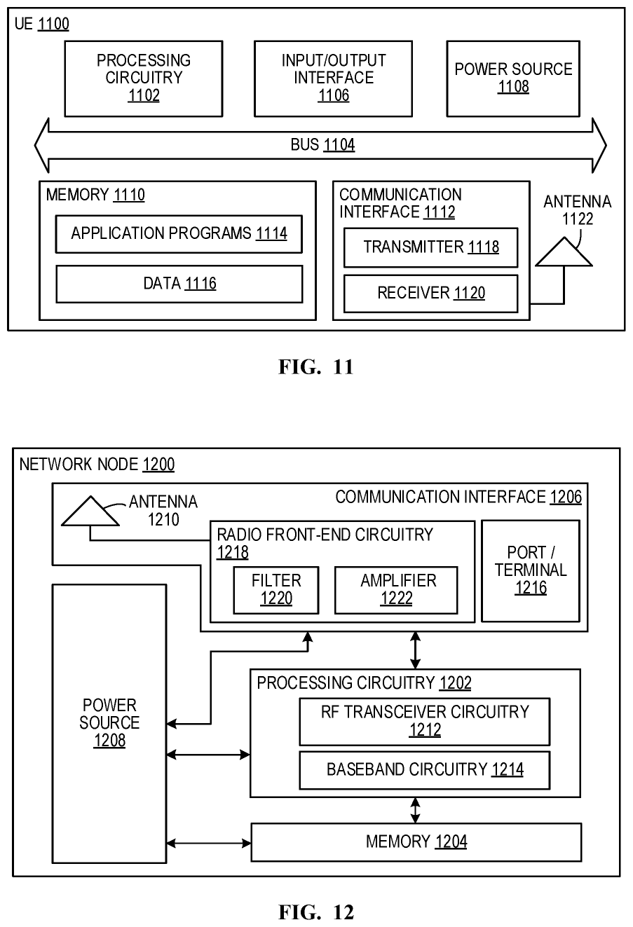

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

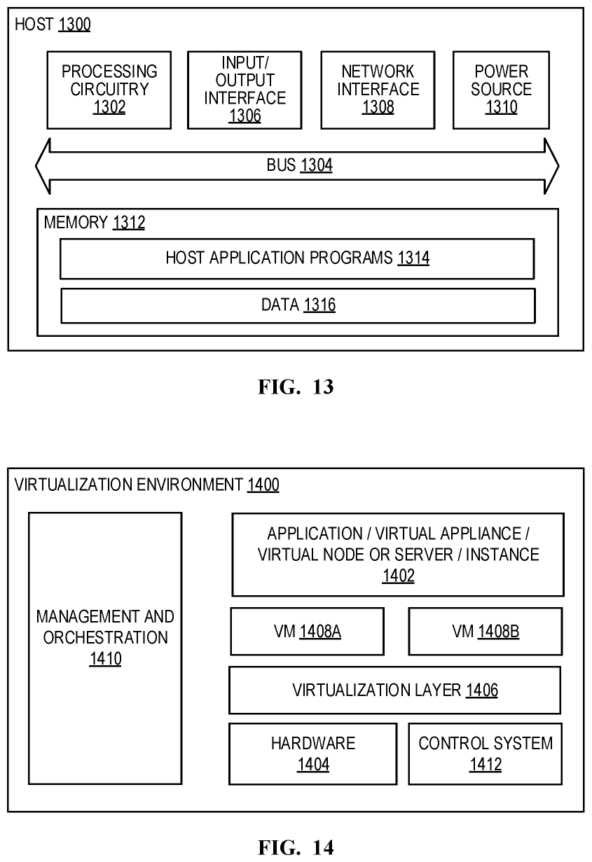

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

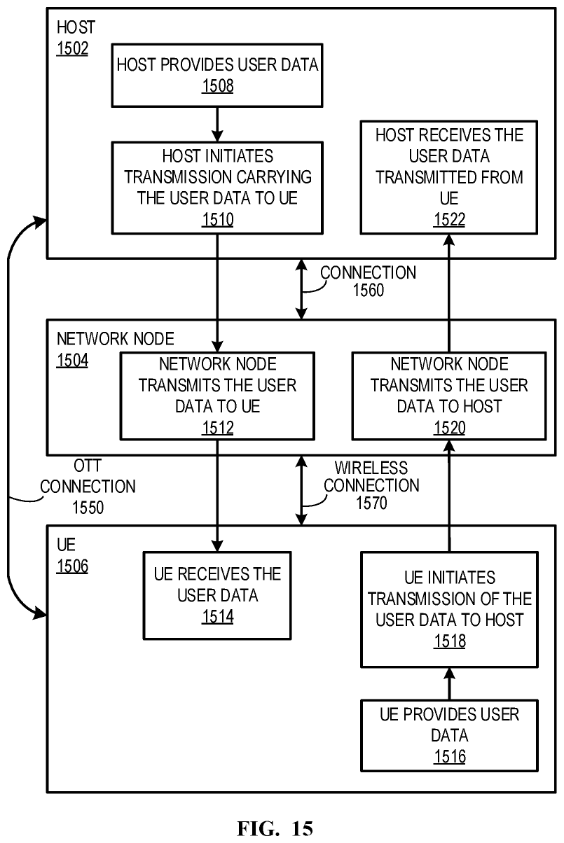

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, improved methods and improved apparatuses for managing data channel for terminal device may be provided. By an indication indicating to allow a first type of traffic of the terminal device, and to deny a second type of traffic of the terminal device, the actions of the terminal device could be better supervised. Even when the terminal device does not provide enough registration information or is already in arrears, the terminal device needs not to be deactivated. It is particularly applicable to for those terminal devices related to safety of the user, such as vehicle, wearable devices etc. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:

The compliance of MIIT NO.246 document, https://www.miit.gov.cn/jgsj/waj/wjfb/art/2021/art_075b1bb3761943af96c4af9df4b4fb5b.html;

The Mobile Economy 2020, GSMA (Global System for Mobile communications

Association), https://www.gsma.com/mobileeconomy/wp-content/uploads/2020/03/GSMA_MobileEconomy2020_Global.pdf;

3GPP TS 32.298 V8.22.0 (2016-06))

3GPP TS 23.502 V17.6.0 (2022-09)

| ABBREVIATION | EXPLANATION |
|---|---|
| 3GPP | Third Generation Partnership Project |
| 5G NR | 5G New Radio |
| AMF | Access and Mobility Management Function |
| AVP | Attribute Value Property |
| BS | Billing System |
| Vehicle DCM | Vehicle Data Communication Module |
| BSC | Base Station Controller for 2G |
| CHF | Charging Function |
| CAI3G | Customer Administrator Interface 3rd Generation |
| CC | Charging Characteristic |
| CDR | Charging Data Record |
| CUDB | Centralized User Database |
| CV | Connected Vehicle |
| DPI | Deep Packet Inspection |
| eNodeB | Base station in the LTE radio network (4G) |
| gNodeB | gNB/gNodeB is the new base station in 5G New |
| | Radio |
| EPC | Evolved Packet Core |
| GPRS | General Packet Radio Service |
| GGSN | Gateway GPRS Support Node |
| HSS-FE | Home Subscriber Server-front end |
| IOT | Internet of Things |
| IOV | Internet of Vehicle |
| LDAP | Lightweight Directory Access Protocol |
| LTE | Long Term Evolution (4G) |
| MME | Mobility Management Entity |
| PGW | PDN Gateway/Data Gateway |
| PCRF | Policy Charging Rule Function |
| PDN | Packet Data Network |
| PG | Provision Gateway |
| RG | Rating Group |
| RNC | Radio Network Controller in WCDMA (3G) |
| SGSN | Serving GPRS Support Node |
| SGW | Serving Gateway |
| SIM card | Subscriber Identity Module card |
| SDID | Service Data ID |
| SMF | Session Management Function |
| UDM | Unified Data Management |

1-22. (canceled)

23. A method performed by a first network node, comprising:
receiving a request for setting an indication for a terminal device;
wherein the indication indicates to allow a first type of traffic of the terminal device, and to deny a second type of traffic of the terminal device.

24. The method according to claim 23, wherein request is from a portal and/or a billing system, when the terminal device lacks credit and/or lacks required information.

25. The method according to claim 23, wherein the indication comprises a charging characteristics value.

26. The method according to claim 23, further comprising:
transmitting the indication for the terminal device to a network storage node.

27. The method according to claim 26, wherein the network storage node comprises a Centralized User Database (CUDB) or a Unified Data Repository (UDR).

28. The method according to claim 23, further comprising:
merging the indication with data from the network storage node and/or a network data management node.

29. The method according to claim 28, wherein the network data management node comprises a Unified Data Management (UDM) or a Home Subscriber Server (HSS).

30. The method according to claim 23, further comprising:
transmitting a response with respect to the request.

31. The method according to claim 23, wherein the first type of traffic is for emergency data services, and/or wherein the first network node comprises a provision gateway (PG) or a provision server.

32. A method performed by a second network node, comprising:
receiving an indication indicating to allow a first type of traffic of a terminal device and to deny a second type of traffic of the terminal device; and
allowing the first type of traffic of the terminal device and denying the second type of traffic of the terminal device.

33. The method according to claim 32, wherein the second network node receives the indication from a Serving GateWay (SGW) during an initial attach procedure of the terminal device.

34. The method according to claim 32, wherein the second network node receives the indication from a Serving GateWay (SGW) during a re-attach procedure initiated by a network side.

35. The method according to claim 32, comprising:
determining whether a traffic of the terminal device is the first type or the second type, based on an identity of a node communicating with the terminal device included in the traffic of the terminal device.

36. The method according to claim 35, wherein the second network node obtains the identity of the node, by using internet protocol packet inspection to the traffic of the terminal device.

37. The method according to claim 35, wherein the identity of the node comprises an internet protocol domain, and/or a Uniform Resource Location (URL); and
wherein the second network node determines the traffic of the terminal device is the first type, when the identity of the node is a preconfigured internet protocol domain, and/or a preconfigured URL.

38. The method according to claim 32, wherein the indication comprises a charging characteristics value.

39. The method according to claim 32, wherein the first type of traffic is for emergency data services and/or wherein the second network node comprises a Public Data Network Gateway (PGW) and/or wherein the indication is caused when the terminal device lacks credit and/or lacks required information.

40. An apparatus for a first network node, comprising:
a memory containing instructions; and
a processor operative to execute the instructions, whereby the processor is configured to:
receive a request for setting an indication for a terminal device;
wherein the indication indicates to allow a first type of traffic of the terminal device, and to deny a second type of traffic of the terminal device.
